(19) United States
(12) Patent Application Publication
(10) Pub. No.: US 2024/0098854 A1
(43) Pub. Date: Mar. 21, 2024

(54) INDUCTION-HEATING-TYPE COOKTOP

(71) Applicant: LG ELECTRONICS INC., Seoul (KR)

(72) Inventors: Hyunwook MOON, Seoul (KR); Kyunghoon JUNG, Seoul (KR); Jaewoo LEE, Seoul (KR); Yangkyeong KIM, Seoul (KR)

(73) Assignee: LG ELECTRONICS INC., Seoul (KR)

(21) Appl. No.: 18/276,506

(22) PCT Filed: Apr. 9, 2021
(86) PCT No.: PCT/KR2021/004468

§ 371 Date: Aug. 9, 2023

(30) Foreign Application Priority Data
Feb. 23, 2021 (KR) 10-2021-0023908

(51) Int. Cl. H05B 6/12

(52) U.S. Cl. CPC H05B 6/1245

(57) ABSTRACT

An induction heating type cooktop can include first and second working coils configured to generate a magnetic field for heating a cooking container; an inverter configured to supply current to one or more of the first working coil and the second working coil; and first and second resonance capacitors configured to resonate with the first and second working coils. Also, the induction heating type cooktop can further include a switching part configured to selectively direct current through one of the first and second working coils or through both of the first and second working coils based on a type of the cooking container.

### CROSS-REFERENCE TO RELATED APPLICATIONS

This application is the National Phase of PCT International Application No. PCT/KR2021/004468, filed on Apr. 9, 2021, which claims priority under 35 U.S.C. § 119(a) to Korean Patent Application No. 10-2021-0023908 filed in the Republic of Korea on Feb. 23, 2021, all of which are hereby expressly incorporated by reference into the present application.

### BACKGROUND

### Technical Field

The present disclosure relates to an induction heating-type cooktop, and more particularly, to an induction heating-type cooktop capable of heating both a magnetic substance and a non-magnetic substance.

### Discussion of Related Art

Various types of cooking appliances are used to heat food at home or in the restaurant. According to the related art, a gas stove using gas as a fuel source has been widely used. However, recently, devices for heating an object to be heated, for example, a cooking container such as a pot, have been using electricity instead of the gas.

A method for heating the object to be heated using electricity is largely divided into a resistance heating method and an induction heating method. The electrical resistance method is a method for heating an object by transferring heat generated when electric current flows through a metal resistance wire or a non-metal heating body such as silicon carbide to the object to be heated (e.g., a cooking container) through radiation or conduction. In the induction heating method, when high-frequency power having a predetermined intensity is applied to a coil, eddy currents are generated in the object to be heated using magnetic fields generated around the coil so that the object is heated.

In the situation of such an induction heating method, there is a problem in that even when the same current is applied to a coil, output power varies depending on the type of material of the cooking container. Specifically, a non-magnetic container has smaller specific resistance in the same operating frequency band due to lower magnetic permeability than that of a magnetic container, and thus the heating output of the non-magnetic container is less than that of the magnetic container.

Thus, a method for improving an output of not only the magnetic type of container but also the non-magnetic type of container is desired. That is, a cooktop capable of heating both the magnetic type of container and the non-magnetic type of container at a high output is desired.

Japanese Patent Registration No. 4978059, which is a related art document, discloses a structure in which a short/open changing means is controlled so that composite capacitance of a resonance capacitor becomes small when a low-resistance non-magnetic metal is heated. However, since the composite inductance is fixed in the cooktop according to the above-mentioned related art document, there is a problem in that the working coil has to be designed based on either a magnetic container or a non-magnetic container. As an example, it is assumed that the working coil is designed based on the magnetic container, the composite inductance is designed to have a relatively small value for a high output. Here, there is a problem in that a non-magnetic container having very low coupling resistance requires a considerably large resonance current in order to be heated at a high output.

### SUMMARY OF THE DISCLOSURE

An object of the present disclosure is to solve the above problems.

An object of the present disclosure is to provide a cooktop capable of heating both a magnetic type of container and a non-magnetic type of container at a high output.

An object of the present disclosure is to provide a cooktop that is capable of adjusting both composite capacitance and composite inductance while sharing a resonance network.

An object of the present disclosure is to provide a cooktop capable of securing a higher withstand voltage when heating a non-magnetic container than when heating a magnetic container.

A cooktop according to the present disclosure can be designed to control composite capacitance as well as composite inductance by sharing a resonance network regardless of the type of cooking container.

A cooktop according to the present disclosure can include a plurality of switches connecting at least one working coil to at least one resonance capacitor according to which type of cooking container is being used.

A cooktop according to the present disclosure can be designed so that a variable resonance capacitor is in a serial connection or series-parallel structure according to the type of cooking container.

### Advantageous Effects

According to the present disclosure, since both the composite capacitance and the composite inductance are adjusted according to the type of cooking container, there can be an advantage in not supplying an excessively large resonance current to the working coil.

According to the present disclosure, since the resonance network is shared, the volume or size of the cooktop can be reduced and the cost of the element can be minimized when compared to the situation in which the independently driven resonance network is provided.

According to the present disclosure, since the large resonance current is distributed through a plurality of switches, there can be an advantage in that high specifications for each switch are not required.

According to the present disclosure, since the withstand voltage when heating a non-magnetic container is secured about twice as high as the withstand voltage when heating the magnetic container, there can be an advantage in that the stability of the product increases and the lifespan of the device can be extended.

### BRIEF DESCRIPTION OF THE DRAWINGS

The above and other objects, features, and advantages of the present disclosure will become more apparent to those of ordinary skill in the art by describing example embodiments thereof in detail with reference to the attached drawings, which are briefly described below.

FIG. 1 is a perspective view illustrating a cooktop and a cooking container according to an embodiment of the present disclosure.

FIG. 2 is a cross-sectional view illustrating the cooktop and the cooking container according to an embodiment of the present disclosure.

FIG. 3 is a circuit diagram of the cooktop according to an embodiment of the present disclosure.

FIG. 4 is a view illustrating output characteristics of the cooktop according to an embodiment of the present disclosure.

FIGS. 5 to 6 are circuit diagrams illustrating a working coil module and a resonance capacitor module of the cooktop according to an embodiment of the present disclosure.

FIGS. 7 to 9 are circuit diagrams illustrating a working coil module and a resonance capacitor module of a cooktop according to another embodiment of the present disclosure.

### DETAILED DESCRIPTION OF THE EMBODIMENTS

Hereinafter, embodiments relating to the present disclosure will be described in detail with reference to the accompanying drawings. Furthermore, terms, such as a “module” ad a “unit,” are used for convenience of description, and they do not have different meanings or functions in themselves.

Hereinafter, an induction heating type cooktop and an operation method thereof according to an embodiment of the present disclosure will be described. For convenience of description, the “induction heating type cooktop” is referred to as a “cooktop.”

The following embodiments can be partially or entirely bonded to or combined with each other and can be linked and operated in technically various ways. The embodiments can be carried out independently of or in association with each other.

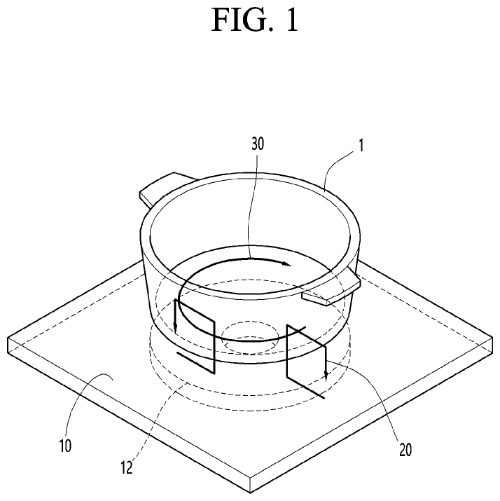

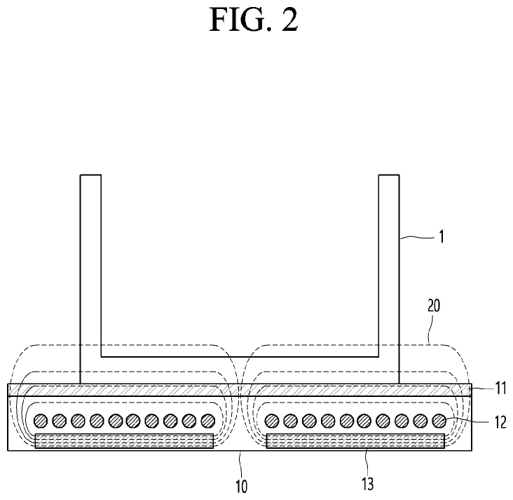

FIG. 1 is a perspective view illustrating a cooktop and a cooking container according to an embodiment of the present disclosure, and FIG. 2 is a cross-sectional view illustrating the cooktop and the cooking container according to an embodiment of the present disclosure.

A cooking container 1 can be disposed above or on the cooktop 10, and the cooktop 10 can heat the cooking container 1 disposed thereon.

First, a method for heating the cooking container 1 using the cooktop 10 will be described.

As illustrated in FIG. 1, the cooktop 10 can generate a magnetic field 20 so that at least a portion of the magnetic field 20 passes through the cooking container 1. Here, if an electrical resistance component is contained in a material of the cooking container 1, the magnetic field 20 can induce an eddy current 30 in the cooking container 1. Since the eddy current 30 generates heat in the cooking container 1 itself, and the heat is conducted or radiated up to the inside of the cooking container 1, contents of the cooking container 1 can be cooked.

When the material of the cooking container 1 does not contain the electrical resistance component, the eddy current 30 does not occur. Thus, in this situation, the cooktop 10 may not heat the cooking container 1.

As a result, the cooking container 1 capable of being heated by the cooktop 10 can be a stainless steel container or a metal container such as an enamel or cast iron container.

Next, a method for generating the magnetic field 20 by the cooktop 10 will be described.

As illustrated in FIG. 2, the cooktop 10 can include one or more of an upper plate glass 11, a working coil 12, or a ferrite 13.

The upper plate glass 11 can support the cooking container 1. That is, the cooking container 1 can be placed on a top surface of the upper plate glass 11.

In addition, the upper plate glass 11 can be made of ceramic tempered glass obtained by synthesizing various mineral materials. Thus, the upper plate glass 11 can protect the cooktop 10 from an external impact.

In addition, the upper plate glass 11 can prevent foreign substances such as dust from being introduced into the cooktop 10.

The working coil 12 can be disposed below the upper plate glass 11. Current can be supplied to the working coil 12 to generate the magnetic field 20. Specifically, the current can flow through the working coil 12 according to on/off of an internal switching element of the cooktop 10.

When the current flows through the working coil 12, the magnetic field 20 can be generated, and the magnetic field 20 can generate the eddy current 30 by meeting the electrical resistance component contained in the cooking container 1. The eddy current can heat the cooking container 1, and thus, the contents of the cooking container 1 can be cooked.

In addition, heating power of the cooktop 10 can be selectively adjusted according to an amount of current flowing through the working coil 12. As a specific example, as the current flowing through the working coil 12 increases, the magnetic field 20 can become stronger, and thus, since the magnetic field passing through the cooking container 1 increases, the heating power of the cooktop 10 can increase.

The ferrite 13 is a component for protecting an internal circuit of the cooktop 10. Specifically, the ferrite 13 serves as a shield to block an influence of the magnetic field 20 generated from the working coil 12 or an electromagnetic field generated from the outside on the internal circuit of the cooktop 10.

For this, the ferrite 13 can be made of a material having very high magnetic permeability. The ferrite 13 serves to induce the magnetic field introduced into the cooktop 10 to flow through the ferrite 13 without being radiated through to the other side of the ferrite 13. The movement of the magnetic field 20 generated in the working coil 12 by the ferrite 13 can be as illustrated in FIG. 2.

The cooktop 10 can further include components other than the upper glass 11, the working coil 12, and the ferrite 13 described above. For example, the cooktop 10 can further include an insulator disposed between the upper plate glass 11 and the working coil 12. That is, the cooktop according to the present disclosure is not limited to the cooktop 10 illustrated in FIG. 2.

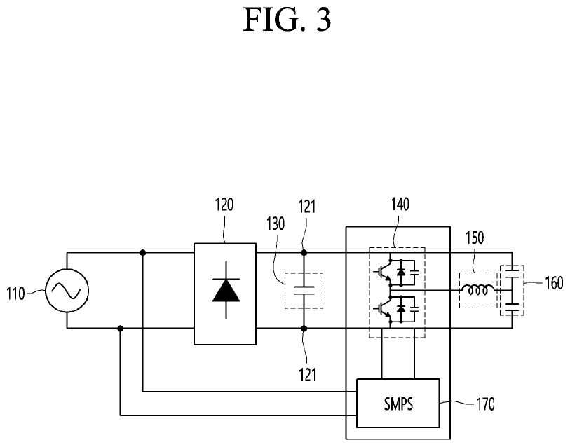

FIG. 3 is a circuit diagram of the cooktop according to an embodiment of the present disclosure.

Since the circuit diagram of the cooktop 10 illustrated in FIG. 3 is merely illustrative for convenience of description, the embodiment of the present disclosure is not limited thereto.

Referring to FIG. 3, the induction heating type cooktop can include at least some or all of a power supply 110 (e.g., an AC power source), a rectifier 120, a DC link capacitor 130, an inverter 140, a working coil 150, a resonance capacitor 160, and a switching mode power supply (SMPS) 170.

The power supply 110 can receive external power. Power received from the outside to the power supply 110 can be alternating current (AC) power.

The power supply 110 can supply an AC voltage to the rectifier 120.

The rectifier 120 is an electrical device for converting alternating current into direct current. The rectifier 120 converts the AC voltage supplied through the power supply 110 into a DC voltage. The rectifier 120 can supply the converted voltage to both DC ends 121 of the DC link capacitor 130.

An output terminal of the rectifier 120 can be connected to both of the DC ends 121 of the DC link capacitor 130. Each of the ends 121 of the DC output through the rectifier 120 can be referred to as a DC link. A voltage measured at each of both the DC ends 121 is referred to as a DC link voltage.

A DC link capacitor 130 serves as a buffer between the power supply 110 and the inverter 140. Specifically, the DC link capacitor 130 is used to maintain the DC link voltage converted through the rectifier 120 to supply the DC link voltage to the inverter 140.

The inverter 140 serves to switch the voltage applied to the working coil 150 so that high-frequency current flows through the working coil 150. The inverter 140 can include a semiconductor switch, and the semiconductor switch can include an insulated gate bipolar transistor (IGBT) or an SiC element. Since this is merely an example, the embodiments are not limited thereto. The inverter 140 drives the semiconductor switch to allow the high-frequency current to flow in the working coil 150, and thus, high-frequency magnetic fields are generated in the working coil 150.

In the working coil 150, current can flow depending on whether the switching element is driven. When current flows through the working coil 150, magnetic fields are generated. The working coil 150 can heat a cooking appliance by generating the magnetic fields as the current flows.

One side of the working coil 150 is connected to a connection point of the switching element of the inverter 140, and the other side of the working coil 150 is connected to the resonance capacitor 160.

The switching element is driven by a driver, and a high-frequency voltage is applied to the working coil 150 while the switching element operates alternately by controlling a switching time output from the driver. In addition, since a turn on/off time of the switching element applied from the driver is controlled in a manner that is gradually compensated, the voltage supplied to the working coil 150 is converted from a low voltage into a high voltage.

The resonance capacitor 160 can be a component to serve as a buffer. The resonance capacitor 160 controls a saturation voltage increasing rate during the turn-off of the switching element to affect an energy loss during the turn-off time.

The SMPS 170 (switching mode power supply) refers to a power supply that efficiently converts power according to a switching operation. The SMPS 170 converts a DC input voltage into a voltage that is in the form of a square wave and then obtains a controlled DC output voltage through a filter. The SMPS 170 can minimize unnecessary loss by controlling a flow of the power using a switching processor.

In cooktop 10 expressed by the circuit diagram illustrated in FIG. 3, a resonance frequency is determined by an inductance value of the working coil 150 and a capacitance value of the resonance capacitor 160. Then, a resonance curve can be formed around the determined resonance frequency, and the resonance curve can represent output power of the cooktop 10 according to a frequency band.

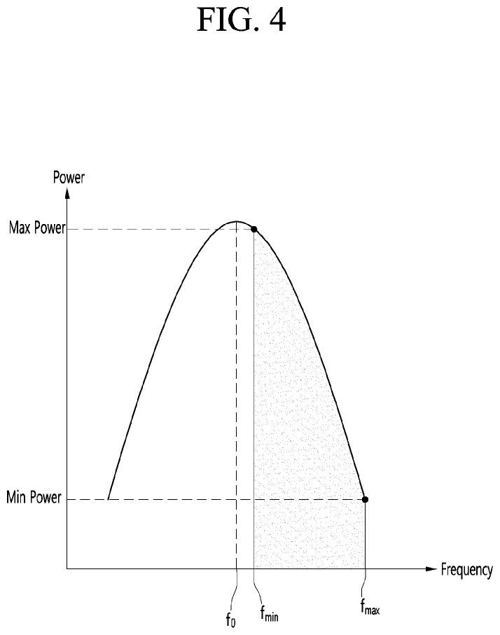

Next, FIG. 4 is a view illustrating output characteristics of the cooktop according to an embodiment of the present disclosure.

First, a Q factor (quality factor) can be a value representing sharpness of resonance in the resonance circuit. Therefore, in the cooktop 10, the Q factor is determined by the inductance value of the working coil 150 included in the cooktop 10 and the capacitance value of the resonance capacitor 160. The resonance curve can be different depending on the Q factor. Thus, the cooktop 10 has different output characteristics according to the inductance value of the working coil 150 and the capacitance value of the resonance capacitor 160.

FIG. 4 illustrates an example of the resonance curve according to the Q factor. In general, the larger the Q factor, the sharper the shape of the curve, and the smaller the Q factor, the broader the shape of the curve.

A horizontal axis of the resonance curve can represent a frequency, and a vertical axis can represent output power. A frequency at which maximum power is output in the resonance curve is referred to as a resonance frequency f₀.

In general, the cooktop 10 uses a frequency in a right region based on the resonance frequency f₀ of the resonance curve (e.g., a point to the right of f₀). In addition, the cooktop 1 can have a minimum operating frequency and a maximum operating frequency, which are set in advance.

For example, the cooktop 10 can operate at a frequency corresponding to a range from the minimum operating frequency fₘᵢₙ to the maximum operating frequency fₘₐₓ. That is, the operating frequency range of the cooktop 10 can be from the minimum operating frequency fₘᵢₙ to the maximum operating frequency fₘₐₓ.

For example, the maximum operating frequency fₘₐₓ can be an IGBT maximum switching frequency. The IGBT maximum switching frequency can mean a maximum driving frequency in determined consideration of a resistance voltage and capacity of the IGBT switching element. For example, the maximum operating frequency fₘₐₓ can be 75 kHz.

The minimum operating frequency fₘᵢₙ can be about 20 kHz. In this situation, since the cooktop 10 does not operate at an audible frequency (about 16 Hz to 20 kHz), noise of the cooktop 10 can be reduced.

Since setting values of the above-described minimum operating frequency fₘᵢₙ and maximum operating frequency fₘₐₓ are only examples, the embodiments of the present disclosure are not limited thereto.

When receiving a heating command, the cooktop 10 can determine an operating frequency according to a heating power level set by the heating command. Specifically, the cooktop 10 can dynamically adjust the output power by decreasing in operating frequency as the set heating power level is higher and increasing in operating frequency as the set heating power level is lower. That is, when receiving the heating command, the cooktop 10 can perform a heating mode in which the cooktop operates in one of the operating frequency ranges according to the set heating power.

An output of the cooktop 10 can vary according to the type of cooking container that is being used, even if the set heating level is the same. For example, even if the heating level set in the cooktop 10 is the same, the output when the cooking container is made of the magnetic substance can be higher than the output when the cooking container is made of the non-magnetic substance.

In order to solve this problem, the cooktop 10 can adjust the composite capacitance of the resonance capacitor according to which type of cooking container is being used (e.g., the magnetic type or the non-magnetic type).

In particular, the cooktop 10 according to an embodiment of the present disclosure adjusts the composite inductance together with the composite capacitance according to which type of cooking container is being used. Here, a resonance network of the cooktop 10 can be designed to be shared, that is, to always resonate at least one working coil and at least one resonance capacitor regardless of which type of cooking container is being used. In this way, resources can be conserved, the size of the device be made smaller, and manufacturing costs can be reduced.

For this, the cooktop 10 according to an embodiment of the present disclosure can include a working coil module (e.g., working coil part or working coil circuit) including a plurality of working coils and a resonance capacitor module including a plurality of resonance capacitors. In addition, current can selectively flow through some of the plurality of working coils and some of the plurality of resonance capacitors according to the type of the cooking container 1 (e.g., the magnetic type or the non-magnetic type).

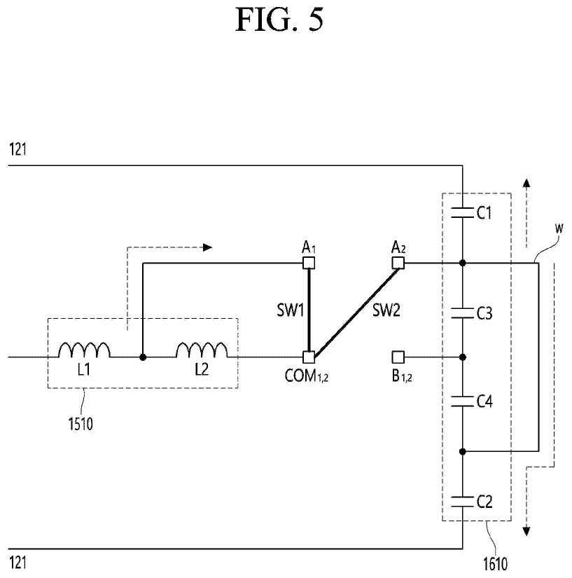

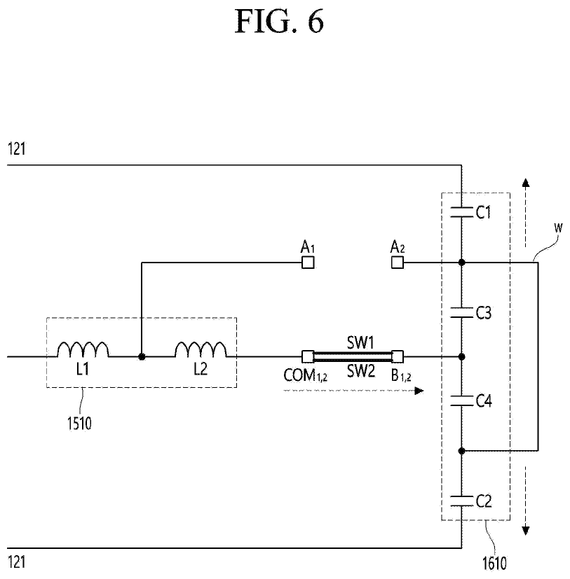

FIGS. 5 to 6 are circuit diagrams illustrating the working coil module 1510 (e.g., working coil part or working coil circuit) and the resonance capacitor module 1610 (e.g., resonance capacitor part or resonance capacitor circuit) of the cooktop according to an embodiment of the present disclosure.

An arrow expressed by dotted line shown in FIGS. 5 and 6 can indicate current.

The cooktop 10 according to an embodiment of the present disclosure can include the working coil module 1510 instead of the working coil 150 described in FIG. 3 and a resonance capacitor module 1610 instead of the resonance capacitor 160 described in FIG. 3.

The working coil module 1510 can include a plurality of working coils 150 described in FIG. 3. In FIG. 5, the working coil module 1510 is illustrated as including first and second working coils L1 and L2, but since the number of working coils is merely an example, embodiments of the present disclosure are not limited thereto.

The resonance capacitor module 1610 can include a plurality of resonance capacitors 160 described in FIG. 3. Similarly, although the resonance capacitor module 1610 in FIG. 5 is illustrated as including first to fourth resonance capacitors C1, C2, C3, and C4, the number of resonance capacitors is merely an example and embodiments of the present disclosure are not limited thereto.

The first and second working coils L1 and L2 can generate a magnetic field so that the cooking container 1 is heated. The inverter 140 can supply current to one or more of the first and second working coils L1 and L2.

The resonance capacitor module 1610 can include first resonance capacitor modules C1 and C2 and second resonance capacitor modules C3 and C4, the first resonance capacitor module can include first and second resonance capacitors C1 and C2, and the second resonance capacitor module can include third and fourth resonance capacitors C3 and C4. Here, both the number of resonance capacitors constituting the first resonance capacitor modules and the number of resonance capacitors constituting the second resonance capacitor modules are merely examples, but embodiments of the present disclosure are not limited thereto.

The first and second resonance capacitor modules can resonate with at least some or all of the first and second working coils L1 and L2.

As illustrated in FIGS. 5 and 6, current can selectively flow through the second working coil L2 and the second resonance capacitor module. In more detail, current can selectively flow through the second working coil L2 and the second resonance capacitor module according to the type of cooking container. For example, as shown in FIG. 5, when the cooking container 1 is made of the magnetic substance (e.g., is a magnetic type of cooking container), the current does not flow through the second working coil L2 and the second resonance capacitor modules C3 and C4, and when the cooking container 1 is made of the non-magnetic substance (e.g., is a non-magnetic type of cooking container), the current can flow through the second working coil L2 and the second resonance capacitor modules C3 and C4, as shown in FIG. 6.

FIG. 5 illustrates a structure of a resonance network formed when the cooking container 1 is made of the magnetic substance, and FIG. 6 illustrates a structure of a resonance network formed when the cooking container 1 is made of the non-magnetic substance.

When the cooking container 1 is made of the magnetic substance, as illustrated in FIG. 5, the current can flow through the first working coil L1 and the first resonance capacitor modules C1 and C2. That is, the current can pass through the first working coil L1 and be distributed to the first resonance capacitor C1 and the second resonance capacitor C2.

When the cooking container 1 is made of the non-magnetic substance, as illustrated in FIG. 6, the current can flow through the first and second working coils L1 and L2 and the first and second resonance capacitor modules C1, C2, C3, and C4. That is, the current can be distributed in a direction of the first and third resonance capacitors C1 and C3 and a direction of the second and fourth resonance capacitors C2 and C4 via the first and second working coils L1 and L2.

For this, the third resonance capacitor C3 and the fourth resonance capacitor C4 can be disposed between the first resonance capacitor C1 and the second resonance capacitor C2, and the cooktop 10 can include a conducting wire W having one end connected between the first resonance capacitor C1 and the third resonance capacitor C3 and the other end connected between the second resonance capacitor C2 and the fourth resonance capacitor C4.

The conducting wire W can be a bypass path that prevents current from passing through the third and fourth resonance capacitors C3 and C4 when the cooking container 1 is made of the magnetic substance. That is, the conducting wire W can guide the current passing through the first working coil L1 to the second resonance capacitor C2 when the cooking container 1 is made of the magnetic substance. The current can selectively flow through the wire W according to the type of the cooking container 1.

In addition, the cooktop 10 can include a first switch SW1 and a second switch SW2, which are driven so that the current selectively flows through the second working coil L2 and the second resonance capacitor modules C3 and C4 according to the type of the cooking container 1.

Each of the first and second switches SW1 and SW2 can be automatically driven according to which type of cooking container is being used (e.g., the magnetic type or the non-magnetic type). For example, each of the first and second switches SW1 and SW2 is driven so that a common terminal is connected to a terminal A when the cooking container 1 is made of the magnetic substance, and the common terminal is connected to a terminal B when the cooking container 1 is made of the non-magnetic substance.

Specifically, in the first switch SW1, the common terminal can be connected to the second working coil L2, the terminal A can be connected between the first working coil L1 and the second working coil L2, and the terminal B can be connected between the third resonance capacitor C3 and the fourth resonance capacitor C4. In the second switch SW2, the common terminal can be connected to the second working coil L2, the terminal A can be connected between the first resonance capacitor C1 and a third resonance capacitor C3, and the terminal B can be connected between the third resonance capacitor C3 and the fourth resonance capacitor C4. Reference numerals COM_{1,2} illustrated in FIGS. 5 and 6 can indicate the common terminal of the first switch SW1 and the common terminal of the second switch SW2, reference numeral A₁ can indicate the terminal A of the first switch SW1, reference numeral A₂ can indicate the terminal A of the second switch SW2, and reference numerals B_{1,2} can indicate the terminal B of the first switch SW1 and the terminal B of the second switch SW2.

As in the present disclosure, when the cooktop 10 includes the plurality of switches driven so that the current selectively flows through the second working coil L2 and the second resonance capacitor module according to the type of the cooking container 1, since the resonance current is distributed to the plurality of switches, there can be an advantage in that high specifications for each switch are not required. That is, there is an advantage in that allowable current required for each switch when the cooktop 10 includes the plurality of switches is less than that required for the switch when the cooktop 10 includes one switch.

The switches SW1 and SW2 can be mechanically driven relay switches or electrically driven IGBTs or SiC. For example, the switches SW1 and SW2 can be relay single pole double through (SPDT).

When the cooking container 1 is made of the magnetic substance, the first and second switches SW1 and SW2 can be driven so that the common terminal and the terminal A are connected to each other. Specifically, when the cooking container 1 is made of the magnetic substance, the common terminal of the first and second switches SW1 and SW2 can operate in a first mode connected to the terminal A. Thus, the current passing through the first working coil L1 can flow through the first resonance capacitor C1 and the second resonance capacitor C2, which are connected in parallel to each other.

When the cooking container 1 is made of the non-magnetic substance, the first and second switches SW1 and SW2 can be driven so that the common terminal and the terminal B are connected, respectively. Specifically, when the cooking container 1 is made of the non-magnetic substance, the common terminals of the first and second switches SW1 and SW2 can operate in a second mode connected to the terminal B. Thus, the current passing through the first and second working coils L1 and L2 can flow through the first resonance capacitor module and the second resonance capacitor module, which are connected in parallel to each other, that is, the first to fourth resonance capacitors C1, C2, C3, and C4. Here, since the first resonance capacitor C1 and the third resonance capacitor C3 are connected in series, and the second resonance capacitor C2 and the fourth resonance capacitor C4 are connected in series, there is an advantage in that the withstand voltage is doubled.

In addition, the composite capacitor when the common terminal of the first and second switches SW1 and SW2 is connected to the terminal A has a value greater than the composite capacitance when the common terminal of the first and second switches SW1 and SW2 is connected to the terminal B. For example, in FIGS. 5 and 6, when it is assumed that the inductance of the first working coil L1 is L1, the inductance of the second working coil L2 is L2, and the capacitance of each of the first to fourth resonant capacitors C1, C2, C3, and C4 is X, if the cooking vessel 1 is made of the magnetic substance, the composite inductance can be L1, and the composite capacitance can be 2X, and if the cooking vessel 1 is made of the non-magnetic substance, the composite inductance can be L1+L2, and the composite capacitance can be X. That is, the composite inductance when heating the magnetic substance is less than the composite inductance when heating the non-magnetic substance, and the composite capacitance when heating the magnetic substance is greater than the composite capacitance when heating the non-magnetic substance.

Thus, since all of the composite capacitance and composite inductance of the cooktop 10 are adjusted according to which type of cooking container is being used, there is an advantage in that a large output is possible regardless of the type of the cooking container 1. In addition, when the cooktop 10 heats the non-magnetic cooking container 1, the composite capacitance can be adjusted to decrease, and a phase margin can be secured. However, since the first and third resonance capacitors C1 and C3 are connected in series, and the second and fourth resonance capacitors C2 and C4 are connected in series, the withstand voltage can be adjusted to increase. In addition, the resonance current when the cooking container 1 is made of the non-magnetic substance can be adjusted so that it is about ½ of the resonance current when the cooking container 1 is made of the magnetic substance.

As described above, in the cooktop 10 according to an embodiment of the present disclosure, when the cooking container 1 is made of the magnetic substance, the first working coil L1 can resonate with the first and second resonance capacitors C1 and C2, and when the cooking container 1 is made of the non-magnetic substance, the first and second working coils L1 and L2 can resonate with the first to fourth resonance capacitors C1, C2, C3, and C4. Thus, it can be confirmed that the working coil L1 and the first and second resonance capacitors C1 and C2 will resonate regardless of the type of cooking container 1. That is, when compared to a situation in which the cooktop 1 includes the working coil and the resonance capacitor that always resonate regardless of the type of cooking container 1, and thus, the resonance network is independently driven according to the type of cooking container 1, there is an advantage of minimizing an increase in volume of the cooktop and an increase in component price. For example, in this way, the cooktop can be made smaller and manufacturing costs can be reduced.

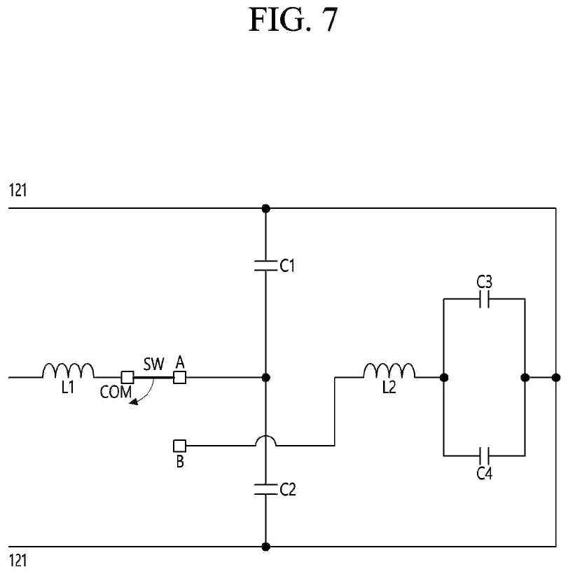

FIGS. 7 to 9 are circuit diagrams illustrating a working coil module and a resonance capacitor module of a cooktop according to another embodiment of the present disclosure.

That is, each embodiment illustrated in FIGS. 7 to 9 can represent an embodiment that is capable of being substituted for the circuit diagrams illustrated in FIGS. 5 to 6 described above.

According to the embodiment illustrated in FIG. 7, a cooktop 10 can include first and second working coils L1 and L2, first to fourth resonance capacitors C1, C2, C3, and C4, and a switch SW. In the switch SW, a common terminal COM can be connected to the first working coil L1, an A terminal A can be connected to a contact point of the first resonance capacitor C1 and the second resonance capacitor C2, and a B terminal B can be connected to the second working coil L2. The capacitance of each of the first and second resonance capacitors C1 and C2 can be Y, and the capacitance of each of the third and fourth resonance capacitors C3 and C4 can be X.

Therefore, in the cooktop 10, when the cooking container 1 is made of a magnetic substance, the first working coil L1 and the first and second resonance capacitors C1 and C2 resonate, and when the cooking container 1 is made of a non-magnetic substance, the first and second working coils L1 and L2 and the third and fourth resonance capacitors C3 and C4 can resonate.

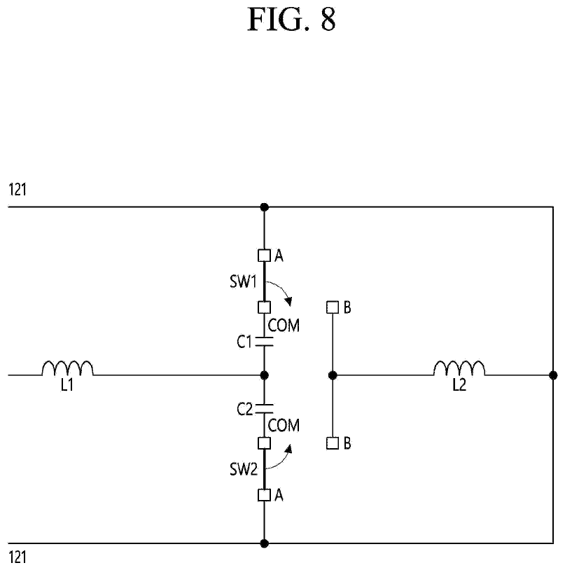

According to the embodiment illustrated in FIG. 8, the cooktop 10 can include first and second working coils L1 and L2, first and second resonance capacitors C1 and C2, and first and second switches SW1 and SW2. In the first switch SW1, a common terminal COM can be connected to the first resonance capacitor C1, an A terminal A can be connected to DC both ends 121, a B terminal B can be connected to a second working coil L2, and in the second switch SW2, a common terminal COM can be connected to a second resonance capacitor C2, and an A terminal A can be connected to DC both ends 121, and a B terminal B can be connected to the second working coil L2. In addition, the first working coil L1 can be connected to a contact point of the first resonance capacitor C1 and the second resonance capacitor C2, and the second working coil L2 can be connected to a contact point of the B terminal B of the first switch SW1 and the B terminal B of the second switch SW2.

Therefore, in the cooktop 10, when the cooking container 1 is made of a magnetic substance, the first working coil L1 and the first and second resonance capacitors C1 and C2 resonate, and when the cooking container 1 is made of a non-magnetic substance, the first and second working coils L1 and L2 and the first and second resonance capacitors C1 and C2 can resonate.

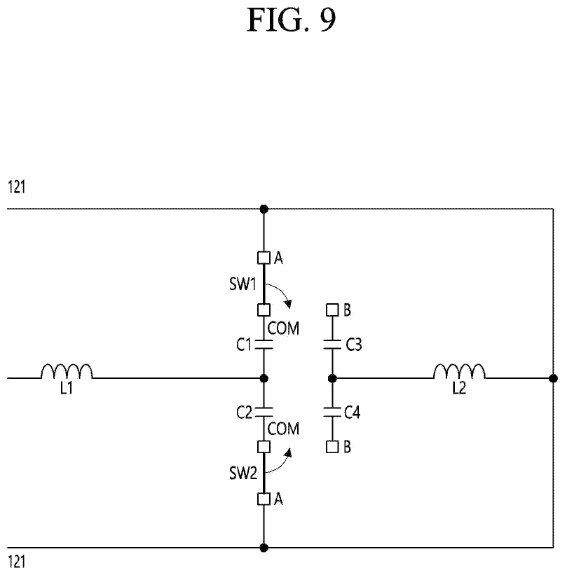

According to the embodiment illustrated in FIG. 9, the cooktop 10 can include first and second working coils L1 and L2, first to fourth resonance capacitors C1, C2, C3, and C4, and first and second switches SW1 and SW2. In the first switch SW1, a common terminal COM can be connected to the first resonance capacitor C1, an A terminal A can be connected to DC both ends 121, a B terminal B can be connected to a third resonance capacitor C3, and in the second switch SW2, a common terminal COM can be connected to a second resonance capacitor C2, and an A terminal A can be connected to DC both ends 121, and a B terminal B can be connected to the fourth resonance capacitor C4. In addition, the first working coil L1 can be connected to a contact point of the first resonance capacitor C1 and the second resonance capacitor C2, and the second working coil L2 can be connected to a contact point of the third resonance capacitor C3 and the fourth resonance capacitor C4.

Therefore, in the cooktop 10, when the cooking container 1 is made of a magnetic substance, the first working coil L1 and the first and second resonance capacitors C1 and C2 resonate, and when the cooking container 1 is made of a non-magnetic substance, the first and second working coils L1 and L2 and the first and fourth resonance capacitors C1, C2, C3, and C4 can resonate.

The above-disclosed subject matter is to be considered illustrative, and not restrictive, and the appended claims are intended to cover all such modifications, enhancements, and other embodiments, which fall within the true spirit and scope of the present disclosure.

Thus, the embodiment of the present disclosure is to be considered illustrative, and not restrictive, and the technical spirit of the present disclosure is not limited to the foregoing embodiment.

Therefore, the scope of the present disclosure is defined not by the detailed description of the invention but by the appended claims, and all differences within the scope will be construed as being included in the present disclosure.

1-10. (canceled)

11. An induction heating type cooktop comprising:
first and second working coils configured to generate a magnetic field for heating a cooking container;
an inverter configured to supply current to one or more of the first working coil and the second working coil;
first and second resonance capacitor parts configured to resonate with the first and second working coils; and
a switching part configured to selectively direct current through the second working coil and the second resonance capacitor part based on a type of the cooking container.

12. The induction heating type cooktop according to claim 11, wherein the switching part is further configured to:
in response to the cooking container being made of a magnetic substance, direct the current to flow through the first working coil and the first resonance capacitor part without flowing through the second working coil and the second resonance capacitor part; and
in response to the cooking container being made of a non-magnetic substance, direct the current to flow through both of the first and second working coils and both of the first and second resonance capacitor parts.

13. The induction heating type cooktop according to claim 11, wherein the first resonance capacitor part includes a first resonance capacitor and a second resonance capacitor,
wherein the second resonance capacitor part includes a third resonance capacitor and a fourth resonance capacitor, the third and fourth resonance capacitors being connected between the first resonance capacitor and the second resonance capacitor, and
wherein the induction heating type cooktop further comprises a wire including a first end connected between the first resonance capacitor and the third resonance capacitor, and a second end connected between the second resonance capacitor and the fourth resonance capacitor.

14. The induction heating type cooktop according to claim 13, wherein the switching part includes a first switch and a second switch, the first and second switches being configured to selectively direct the current to flow through the second working coil and the second resonance capacitor part based on the type of the cooking container.

15. The induction heating type cooktop according to claim 14, wherein a first end of the first switch is connected to the second working coil, and a second end of the first switch is configured to selectively connect to a location between the first working coil and the second working coil and a location between the third resonance capacitor and the fourth resonance capacitor, and
wherein a first end of the second switch is connected to the second working coil, and a second end of the second switch is configured to selectively connect to a location between the first resonance capacitor and the third resonance capacitor and the location between the third resonance capacitor and the fourth resonance capacitor.

16. The induction heating type cooktop according to claim 15, wherein the first and second switches are configured to, in response the cooking container being made of a magnetic substance, connect the second end of the first switch to the location between the first working coil and the second working coil, and connect the second end of the second switch to the location between the first resonance capacitor and the third resonance capacitor, in order to direct the current to flow through the first resonance capacitor part.

17. The induction heating type cooktop according to claim 16, wherein the first resonance capacitor part and the second resonance capacitor part are connected in parallel.

18. The induction heating type cooktop according to claim 16, wherein the first and second switches are further configured to, in response the cooking container being made of a non-magnetic substance, connect the second end of the first switch to the location between location between the third resonance capacitor and the fourth resonance capacitor, and connect the second end of the second switch to the location between the third resonance capacitor and the fourth resonance capacitor, in order to direct the current to flow through both of the first resonance capacitor part and the second resonance capacitor part.

19. wherein the induction heating type cooktop according to claim 18, wherein the first resonance capacitor part and the second resonance capacitor part are connected in parallel.

20. The induction heating type cooktop according to claim 14, wherein the first and second switches are configured to:
in response the cooking container being made of a magnetic substance, adjust a composite capacitance to be a first value; and
in response the cooking container being made of a magnetic substance, adjust the composite capacitance to be a second value, and
wherein the second value is less than the first value.

21. The induction heating type cooktop according to claim 11, wherein the switching part includes a plurality of switches.

22. An induction heating type cooktop comprising:
first and second working coils configured to generate a magnetic field for heating a cooking container;
an inverter configured to supply current to one or more of the first working coil and the second working coil;
first, second, third and fourth resonance capacitors configured to resonate with the first and second working coils; and
a switching part configured to:
in response to operating in a first mode, direct the current to flow through the first working coil and both of the first and second resonance capacitors without flowing through the second working coil and the third and fourth resonance capacitors; and
in response to operating in a second mode, direct the current to flow through both of the first and second working coils and all of the first, second, third and fourth resonance capacitors.

23. The induction heating type cooktop according to claim 22, wherein the switching part is further configured to:
in response to operating in the first mode, adjust a composite capacitance to be a first value; and
in response to operating in the second mode, adjust the composite capacitance to be a second value, and
wherein the second value is less than the first value.

24. The induction heating type cooktop according to claim 22, wherein the first mode corresponds to a magnetic type of cooking container being placed on the induction heating type cooktop, and
wherein the second mode corresponds to a non-magnetic type of cooking container being placed on the induction heating type cooktop.

25. The induction heating type cooktop according to claim 22, wherein the switching part includes a first switch and a second switch.

26. The induction heating type cooktop according to claim 25, wherein a first end of the first switch is connected to the second working coil, and a second end of the first switch is configured to selectively connect to a location between the first working coil and the second working coil and a location between the third resonance capacitor and the fourth resonance capacitor, and
wherein a first end of the second switch is connected to the second working coil, and a second end of the second switch is configured to selectively connect to a location between the first resonance capacitor and the third resonance capacitor and a location between the third resonance capacitor and the fourth resonance capacitor.

27. An induction heating type cooktop comprising:
a plurality of working coils configured to generate a magnetic field for heating a cooking container;
an inverter configured to supply current to one or more of the plurality of working coils; and
a plurality of resonance capacitor parts configured to resonate with the plurality of working coils,
wherein the current selectively flows through one or more of the plurality of working coils and one or more of the plurality of resonance capacitors based on a type of the cooking container.

28. The induction heating type cooktop according to claim 27, wherein when the cooking container is a magnetic type of cooking container, the current flows through only some of the plurality of working coils and only some of the plurality of resonance capacitors.

29. The induction heating type cooktop according to claim 27, wherein when the cooking container is a non-magnetic type of cooking container, the current flows through all of the plurality of working coils and all of the plurality of resonance capacitors.

30. The induction heating type cooktop according to claim 27, wherein the plurality of working coils are connected in series, and
wherein the plurality of resonance capacitors are connected in series between two output ends of the inverter.
